(19) United States
(12) Patent Application Publication
(10) Pub. No.: US 2006/0091201 A1
(43) Pub. Date: May 4, 2006

(54) Fueling system

(76) Inventor: Peter M. Simonson, Miami Beach, FL (US)

Correspondence Address: AKERMAN SENTERFITT, P.O. BOX 3188, WEST PALM BEACH, FL, 33402-3188, US

(21) Appl. No.: 10/980,042

(22) Filed: Nov. 3, 2004

(51) Int. Cl. G06F 7/08

(52) U.S. Cl. 235/381

(57) ABSTRACT

A system for fueling vehicles or engines includes a fuel pump having a nozzle. Indicia coding at least for vehicle-related or engine-related information is positioned on the vehicle or engine. A reader of the indicia is provided on the nozzle. A processor is provided for determining the information from the indicia. A method for fueling vehicles and engines is also disclosed.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

This invention relates generally to the field of fueling systems and, more particularly, to fueling systems for automobiles, planes, boats, and other engines.

### BACKGROUND OF THE INVENTION

Fueling stations can have several different grades of gasoline having different octane ratings, as well as different types of fuels such as diesel, or fuels having ethanol or other ingredients or additives. Placing the wrong fuel in an engine can cause a deterioration in the performance of that engine or, in the worst case, engine damage or failure. In some cases, the operator of the engine does not know the grade or fuel type that is required by the engine. Operator manuals can provide such information; however, such manuals are not always present or are not consulted by the operator. Also when fueling a vehicle, certain information needs to be collected. For example the type, amount, time & date of fueling. This may be used for billing, inventory or safety reasons. For fuel retailers this information is important, but the speed at which it is collected is very important also. The faster the transaction can occur the more fuel that can be sold.

### SUMMARY OF THE INVENTION

A system for fueling vehicles includes a fuel pump having a nozzle. Indicia coding at least for fuel type is provided adjacent to a fuel inlet for the vehicle. A reader of indicia is provided on the nozzle. A processor is provided for determining at least fuel type from said indicia, and for causing the pump to deliver fuel as indicated by the indicia. The indicia can be a bar code and the reader can be an optical scanner. Other types of data entry or transmitting technologies such as radio frequency, magnetic strips, keypads, finger print readers, and the like can be utilized.

A method for fueling a vehicle includes the steps of providing a fuel pump having a nozzle. A reader of indicia is attached to the nozzle. A vehicle is provided having indicia encoded for vehicle-related information such as fuel type or the owner of the vehicle. The indicia is preferably positioned adjacent to the fuel inlet of the vehicle such that insertion of a fuel nozzle in the usual manner will cause the reader to detect the indicia, without effort by the customer. A processor is provided for determining at least fuel type from the indicia. The nozzle is placed into the fuel inlet and the indicia are read by the reader. A signal is sent to the processor, from which the vehicle-related information is determined. The processor can process the vehicle-related information to perform an action, such as, cause the fuel indicated by the indicia to be dispensed from the nozzle, or to cause the charge to be automatically billed to the owner or operator of the vehicle.

A vehicle according to the invention comprises a fuel inlet having adjacent thereto indicia for determining fuel type. The indicia is readable by a reader on the nozzle of a fuel pump.

A fueling system for engines having an associated fuel tank includes a fuel pump having a nozzle. Indicia are provided preferably adjacent to at least a fuel inlet of the vehicle, and code for vehicle-related information such as fuel type or the owner or operator of the vehicle. A reader of the indicia is attached to the nozzle. A processor is provided for processing the vehicle-related information from the indicia, and for causing an appropriate action, such as causing the pump to deliver fuel as indicated by said indicia. The indicia can be a bar code. The reader can comprise an optical scanner.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic diagram of a fueling system according to the invention.

FIG. 2 is a side elevation of a fuel nozzle according to the invention.

FIG. 3 is a side elevation, partially broken away, illustrating a method for fueling according to the invention.

### DETAILED DESCRIPTION OF THE PREFERRED EMBODIMENTS

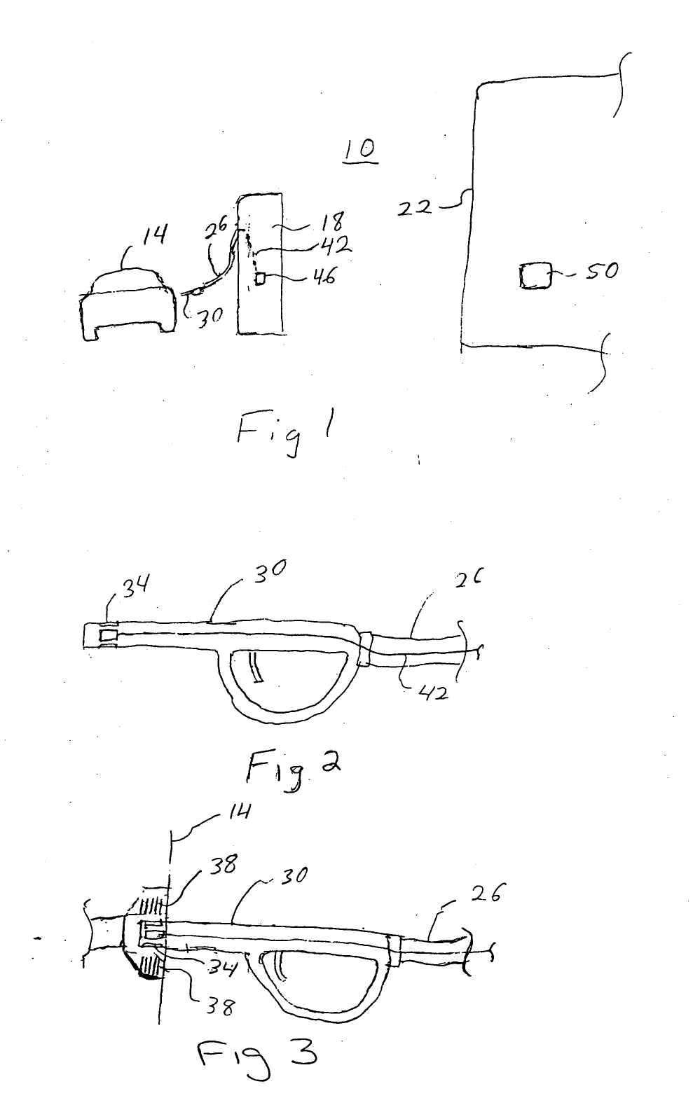

There is shown in FIGS. 1-3, a fuel station 10 according to one aspect of the invention. Although the fuel station 10 is in the form of a typical gas station for vehicles such as automobiles 14, the invention has utility with any fueling station or system for fueling vehicles and other engines. The fueling station 10 has gas pumps 18 and can have a central business location 22. The gas pump 18 can include a fueling hose 26 having a nozzle 30.

The fuel nozzle 30 includes a suitable reader 34 for reading indicia. The reader 34 is adapted to read indicia 38. The reader 34 and indicia 38 can be any suitable reader and indicia combination. The indicia 38 is provided adjacent to a fuel inlet 40 of the vehicle, such that placement of the fuel nozzle 30 in or near the fuel inlet 40 will permit the reader 34 to read the indicia 38. In the embodiment shown, the scanner 34 is an optical scanner and the indicia 38 are optical indicia such as a bar code. The reader 34 detects the indicia 38 and transmits a signal by suitable structure such as signal line 42 to a processor 46. The processor 46 interprets the indicia to provide information regarding the vehicle 14. In one aspect, the indicia is magnetic such as are provided on credit cards, and the reader 34 is a magnetic indicia reading device. The reader 34 can be attached to or formed integral with the fuel nozzle 30. Other types of data entry or transmitting technologies can be utilized, such as radio frequency, magnetic strips, keypads, finger print readers, and the like. Keypads allow the customer or attendant to key in data, and are positioned on the pump in or on the fuel nozzle 30. Finger print readers can be used to recognize the customer, from which related data can be derived from a suitable data store. The indicia can be any suitable vehicle or engine-related information. The information can include, but is not limited to, car or engine type, fuel type, and billing, charge, or credit information of the owner or operator.

The signal from the reader 34 can be transmitted to the processor 46 by any suitable means. The signal line 42 can be a conventional electric signal wire. Other signal transmission devices and systems, including optical fiber and wireless transmission systems, are possible.

The processor 46 can be any suitable processor. The processor 46 can be a stand alone device or can be software operating on a processor that is used for other processing activities. The processor 46 can be located at the pump 18 or can be provided in a remote location such as the central business location 22. A processor 50 can be located in the central business location 22, and can be a stand alone device or can be an integrated device which is used for other station operations. Also, the processor can be located on a remote computing device that is accessed by suitable communications systems such as the Internet.

The processor causes the pump 18 to deliver fuel to the vehicle 14 as indicated by the indicia 38. This can be accomplished by sending an appropriate signal from the processor to pumping or valving circuitry in the pump 18. This will cause the pump 18 to deliver the appropriate grade or type of fuel to the vehicle as required by the indicia 38. Operator error in selecting the appropriate grade or type of fuel will thereby be eliminated.

The invention has utility for various types of engines. These can include different types of vehicles such as automobiles, trucks, boats, planes, motorcycles, snow mobiles, tractors, trains, golf carts, trolleys, cargo transporters, forklifts, farm equipment, and the like. The same system could also be used on a fuel truck to ensure it delivers the correct fuel to a remote location, and to help prevent theft of fuel from fuel trucks. The invention can also be used for other engines such as machinery, generators, pumping stations, cranes, and the like.

The information provided by the indicia 38 can include the type of fuel that is required by the vehicle. Other information can be provided by the indicia. Such other information can include vehicle or engine make and year, engine type, billing, charge or credit information, and other information.

This invention can be embodied in other forms without departing from the spirit or essential attributes thereof and, accordingly, reference should be had to the following claims rather than the foregoing specification as indicating the scope of the invention.

I claim:

1. A system for fueling engines having a fuel tank with a fuel inlet, comprising:
a fuel pump having a nozzle;
indicia coding positioned adjacent to the fuel inlet of said fuel tank, said indicia coding for engine or related information;
a reader for said indicia, said reader being provided on said nozzle; and
a processor for determining from said indicia.

2. The system of claim 1, wherein said indicia comprises bar code and said reader comprises an optical scanner.

3. The system of claim 2, wherein said indicia comprises magnetic data, and said reader comprises a magnetic data reader.

4. The system of claim 1, wherein said vehicle is at least one selected from the group consisting of automobiles, trucks, motorcycles, boats, planes, snow mobiles, tractors, trains, golf carts, trolleys, cargo transporters, forklifts, farm equipment, and fuel trucks.

5. The system of claim 1, wherein the engine is provided as part of a vehicle, and said indicia provides vehicle-related information relating at least to fuel type, and said processor causes said fuel pump to deliver fuel as indicated by said indicia.

6. The system of claim 5, wherein said information comprises at least one selected from the group consisting of fuel type, engine make, vehicle make, owner, operator, billing, charging, and credit information.

7. A fuel pump nozzle comprising a reader of indicia indicating at least fuel type.

8. The fuel pump nozzle of claim 7, further comprising structure for sending a signal corresponding to the indicia to a processor.

9. The fuel pump nozzle of claim 7, wherein said reader comprises an optical scanner.

10. A method for fueling vehicles having a fuel inlet, comprising the steps of:
providing a fuel pump having a nozzle with a reader for indicia;
providing a vehicle having indicia coding information related to the vehicle, said indicia being positioned adjacent to the fuel inlet of said vehicle;
providing a processor for determining vehicle-related information from said indicia, and for causing an action as indicated by said indicia;
placing said nozzle into said fuel inlet, and reading with said reader said indicia adjacent to said fuel inlet opening;
providing a signal from said reader to said processor, said processor determining said action from said signal; and
delivering fuel to said nozzle to said fuel inlet.

11. A fueling system for a vehicle comprising a fuel inlet opening and indicia for indicating at least fuel type for the vehicle, said indicia being substantially adjacent to said fuel inlet opening.

12. The vehicle fueling system of claim 9, wherein said indicia comprises a bar code.

13. The vehicle fueling system of claim 9, wherein said vehicle is at least one selected from the group consisting of automobiles, trucks, motorcycles, boats, planes, snow mobiles, tractors, trains, golf carts, trolleys, cargo transporters, forklifts, farm equipment, and fuel trucks.

14. A fueling system for engines having an associated fuel tank, said fuel tank having a fuel inlet opening, said system comprising:
a fuel pump having a nozzle for delivering fuel to said fuel tank;
indicia coding for at least fuel type for said engines, said indicia being provided adjacent to the fuel inlet of said fuel tank;
a reader of said indicia, said reader being provided on said fuel nozzle; and
a processor for determining at least fuel type from said indicia, and for causing said fuel pump to deliver fuel as indicated by said indicia.

15. The fueling system of claim of claim 14, wherein said indicia comprises a bar code.

16. The fueling system of claim 15, wherein said reader comprises an optical scanner.

17. A vehicle having a fuel tank with an inlet opening and indicia substantially adjacent to said inlet opening such that said indicia can be read by a reader provided on a fuel nozzle.

18. The vehicle of claim 17, wherein said indicia encodes a fuel type for said vehicle.

19. A system for fueling vehicles having a fuel inlet, comprising a fuel pump having a nozzle, and a data entry means provided on said nozzle, data entry being accomplished automatically by said data entry means upon insertion of said nozzle into said fuel inlet.
